(19) United States
(12) Patent Application Publication
(10) Pub. No.: US 2002/0152272 A1
(43) Pub. Date: Oct. 17, 2002

(54) Method for managing multiple dynamic e-mail aliases

(76) Inventor: Rahav Yairi, Arlington, MA (US)

Correspondence Address: BANNER & WITCOFF, 1001 G STREET N W, SUITE 1100, WASHINGTON, DC, 20001, US

(21) Appl. No.: 09/834,264

(22) Filed: Apr. 12, 2001

(51) Int. Cl. G06F 15/16; G09G 5/00

(52) U.S. Cl. 709/206; 345/752

(57) ABSTRACT

A method of managing plural e-mail addresses that allows the user to quickly determine the source of unsolicited e-mail messages is provided. Each user may be provided a main e-mail address and several alias e-mail addresses. The address field of an incoming e-mail message is compared to main and alias addresses included in a database. All e-mail messages addressed to either the main e-mail address or an alias e-mail address are transmitted to a single user in-box. When the source of unsolicited e-mail is determined, the appropriate alias e-mail address can be deleted.

### FIELD OF THE INVENTION

The present invention relates to the field of electronic mail (e-mail) systems. More specifically, the present invention provides a system and method that allows a user to efficiently manage multiple electronic mail addresses.

### BACKGROUND OF THE INVENTION

The use of e-mail by individuals and companies continues to increase. When ordering a product, registering with an online service or otherwise interacting with a public network, users are often requested to identify themselves by their email address. Whenever a user provides their e-mail address to someone, there is always a risk that the recipient of the address will either send unsolicited e-mail messages to the user or sell the user's e-mail address to a third party who may send unsolicited e-mail messages to the user. The problem of unsolicited e-mail is well known and has received considerable attention.

Several attempts have been made to reduce the number of unsolicited e-mail messages that users receive. However, it is often difficult to determine the source of an e-mail message and is often even more difficult to determine how the source of the e-mail message received the user's e-mail address. As an example, robotic delivery programs can send out unsolicited e-mail messages and create nonexistent source e-mail addresses. The user is unable to reply to the e-mail message, because the source e-mail address does not exist, and is also unable to know who to contact to request to be removed from the e-mail list. Furthermore, unsolicited e-mail messages are sometimes sent from abroad, which makes enforcement of privacy laws difficult or impossible.

In an attempt to reduce the number of unsolicited e-mail messages that they receive, some users have resorted to creating several e-mail addresses. A user may create a new e-mail address through a web-based free e-mail provider before conducting a transaction that may lead to the user receiving unsolicited e-mail messages, such as ordering a product from a web site. The user will then order the product and cancel the e-mail address after receiving the product. This method has resulted in users going through the burdensome steps of logging into multiple e-mail address accounts to manage their e-mail accounts.

Therefore, there exists a need in the art for an e-mail system that allows users to conveniently manage their e-mail messages while providing the ability to limit the amount of unsolicited e-mail messages.

### SUMMARY OF THE INVENTION

The present invention provides an e-mail system that allows users to efficiently manage several different e-mail accounts. Among other advantages, the disclosed system allows users to effectively determine the source of unsolicited e-mail messages. E-mail messages addressed to the related e-mail accounts can be delivered to a single in-box and the user may be allowed to add and delete e-mail addresses.

In one embodiment, the advantages of the present invention are realized by a method of routing e-mail messages with a mail server. The method includes the step of receiving an e-mail message having a destination address and receiving from a user at the mail server an identification of a main electronic mail address and at least one alias electronic mail address. Next, the destination address is compared to addresses included in a database of main and alias e-mail addresses. The e-mail message is then transmitted to an address determined as a result of the comparing step. The e-mail message may be transmitted to the destination address when the destination address is indicated as a main address in the database and may be transmitted to a main address when the destination address is indicated as an alias address corresponding to the main address in the database.

In another embodiment of the invention, a method of providing an e-mail service to users is provided. The method includes registering a main electronic mail address for a user and providing at least one alias e-mail address to a user. Electronic messages addressed to the main address and e-mail messages addressed to the at least one alias address are delivered to a single e-mail in-box. The user can create and delete alias e-mail addresses in response to determining that unsolicited e-mail messages are being sent to alias addresses.

### BRIEF DESCRIPTION OF THE DRAWINGS

The present invention is illustrated by way of example and not limited in the accompanying figures in which like reference numerals indicate similar elements and in which:

FIG. 1 shows a block diagram of an e-mail system in accordance with an embodiment of the invention;

FIG. 2 shows a method of routing e-mail messages in accordance with an embodiment of the invention;

FIG. 3 shows a web page that lists a user's e-mail addresses in accordance with an embodiment of the invention; and

FIG. 4 shows a web page that lists the e-mail traffic of a user's alias e-mail address in accordance with an embodiment of the invention.

### DETAILED DESCRIPTION OF PREFERRED EMBODIMENTS

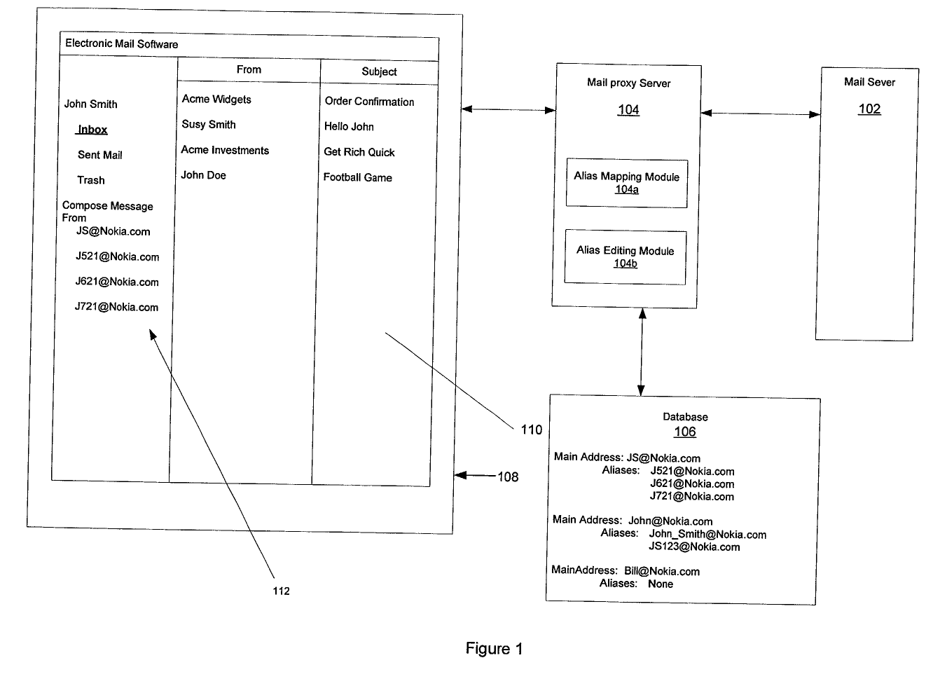

FIG. 1 shows an e-mail system in accordance with a preferred embodiment of the invention. E-mail messages are initially received at a mail server 102. Mail server 102 may be a conventional mail server used to route e-mail messages. E-mail messages are transmitted from mail server 102 to a mail proxy server 104. Mail proxy server 104 may include modules for mapping alias e-mail address 104a and for editing alias e-mail addresses 104b. Mail proxy server 104 may also be connected to a database 106. Database 106 may store a main e-mail address for each user and a number of alias e-mail addresses for each user. The operation of mail proxy server 104 and database 106 will be described below.

Mail proxy server 104 transmits e-mail messages to a user's computer device 108. Computer device 108 may be a personal computer, mobile telephone, personal digital assistant or any other computer device that allows the user to receive e-mail messages. Computer device 108 may include a graphical user interface 110 that allows a user to manage e-mail messages. Graphical user interface 110 shows that John Smith has four e-mail messages in his inbox.

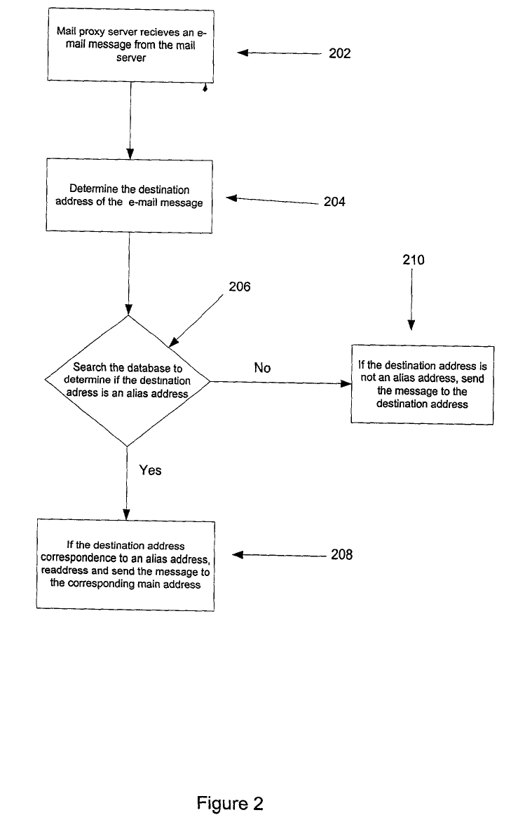

The operation of mail proxy server 104 and database 106 will now be described with reference to FIG. 2. In step 202, mail proxy server 104 receives an e-mail message from mail server 102. Next, in step 204 mail proxy server 104 determines the destination address of the e-mail message. Mail proxy server 104 may include software that retrieves the destination address from the e-mail message. In step 206, mail proxy server 104 searches the information included in database 106 to determine whether the destination address is an alias address. If the destination address corresponds to an alias address, the message is readdressed and sent to the corresponding main address in step 208. If the destination address is not an alias address, the message is sent to the destination address in step 210. One of the advantages of the method shown in FIG. 2 is that the method results in e-mail messages addressed to different e-mail addresses being delivered to a single user e-mail in-box.

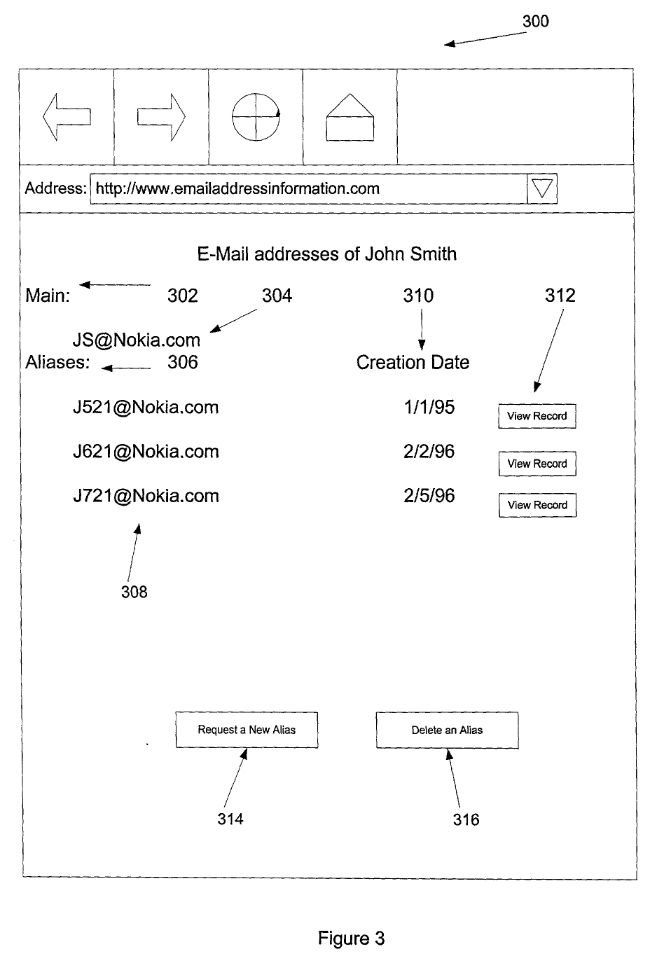

The user of the e-mail system may manage his or her e-mail accounts through software installed on mail proxy server 104 or software installed on computer 108. FIG. 3 shows an embodiment in which the user manages his or her e-mail addresses by interfacing with mail proxy server 104 through a web page 300. In one embodiment of the invention, the user accesses web page 300 by providing the user's main e-mail address and a password. FIG. 3 shows the e-mail addresses belonging to John Smith. The user's main e-mail address 304 is listed under a main heading 302. FIG. 3 shows that John Smith has three alias e-mail addresses listed in addresses column 308 under an aliases heading 306. FIG. 3 shows an embodiment in which the main e-mail address 304 and the alias e-mail addresses have the same domain (Nokia.com). One skilled in the art will appreciate that the present invention can be implemented with several different e-mail address domains. For example, the user may have one e-mail address having a domain corresponding to the user's employer and one or more additional e-mail addresses having different domains. Alternatively, all of a user's alias e-mail addresses may have the same domain and the alias e-mail addresses may have a domain that is different from the user's main e-mail address. The later embodiment allows the user to utilize the same alias e-mail addresses when the user's main e-mail address changes, such as when the user changes employment or Internet service providers.

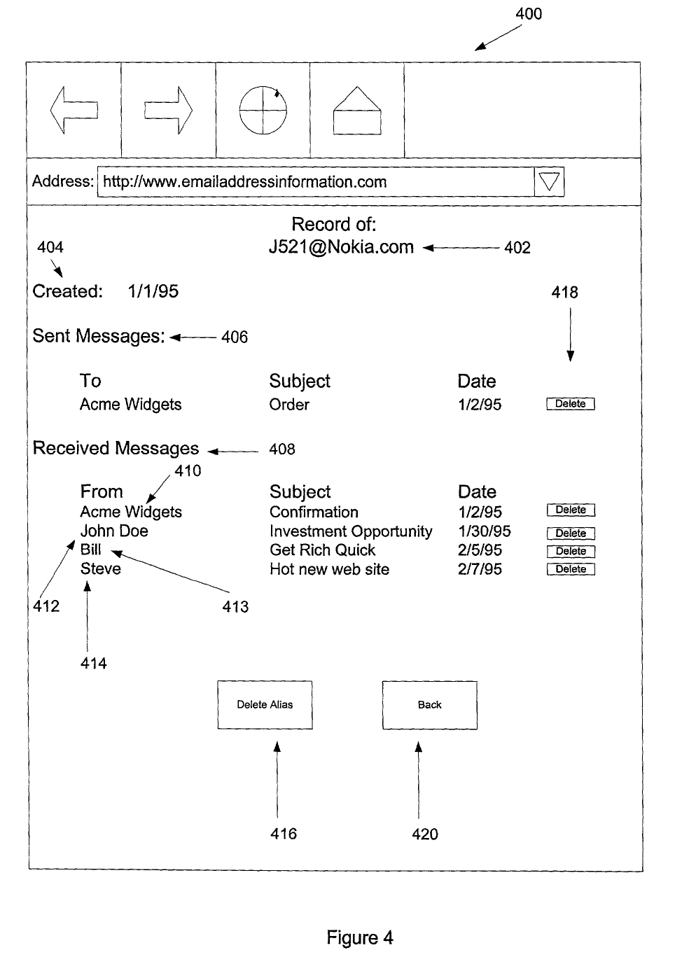

User interface 110 (shown in FIG. 1) includes menu selection options 112 that allow the user to send e-mail messages from either the user's main e-mail address or any one of the user's alias e-mail addresses. Three alias addresses are shown for illustration purposes only and with the understanding that more or fewer alias addresses can be created. The dates of creation of the alias e-mail addresses are shown in a column 310. Another column 312 includes buttons that link to web pages that individually show a record for each one of the alias e-mail addresses. The records will be described below with reference to FIG. 4. Web page 300 may also include a button 314 that allows the user to request a new alias e-mail address. In one embodiment of the invention, the address is selected at random by software installed on computer 110 or on mail proxy server 104. Alternatively, the user may be presented with the option of selecting the alias address. For example, the user may enter a desired alias address and then be notified as to whether the desired address is available or taken by another user. The user may also delete an alias address by highlighting the desired address and selecting a delete button 316. One skilled in the art will appreciate that web page 300 is only one example of the user interface that can be used to manage e-mail addresses and that one skilled in the art could create alternative user interfaces that perform similar or identical functions.

After selecting one of the view record buttons shown in column 312, the user will be linked to a web page that may be similar to web page 400 shown in FIG. 4. Web page 400 includes a heading 402 identifying the alias e-mail address. The date of creation of the alias e-mail address may be included next to a date heading 404. Next, the e-mail messages sent by the user with the alias e-mail address are listed under a sent messages heading 406. Web page 400 shows that J521@Nokia.com sent a single message to Acme Widgets on Jan. 2, 1995 and that the subject of the message is “order.” The e-mail messages received by the user with the alias e-mail address are shown under a received messages heading 408. Web page 400 shows that J521@Nokia.com has received four e-mail messages. E-mail message 410 is likely a confirmation of the user's order. E-mail messages 412-414 are likely unwanted or unsolicited e-mail messages.

One of the advantages of the present invention is that it allows the user to effectively control unsolicited or unwanted e-mail messages. For example, when viewing web page 400, the user would likely determine that Acme Widgets provided or sold the user's e-mail address to others. The user can then select a delete alias button 416 to delete the e-mail alias address from mail proxy server 104 to prevent receiving any additional unsolicited e-mail from that source of unsolicited e-mail. Furthermore, the user may also contact Acme Widgets and express their displeasure with Acme Widgets for providing their e-mail address to others or to alert Acme Widgets that there may have been a security violation or some other problem that resulted in others obtaining the user's e-mail address. Since the user sent a single message with the alias address and the message was sent to Acme Widgets, the user can be confident that Acme Widgets is a source of the unsolicited e-mail.

Of course web page 400 can include other features that allow the user to manage the corresponding alias e-mail address. For example, a column 418 of delete buttons may be included next to each one of listed messages to allow the user to delete any of the listed messages. The user may want to delete messages that were either sent to or received from sources that they believe are unlikely to lead to unsolicited e-mail. A back button 420 may also be included to link the user to a previous web page. In one embodiment of the invention, the information displayed on web page 400 is stored in database 106 (shown in FIG. 1).

The use of more than one e-mail address provides the user with flexibility for managing the flow of information. For example, the user can create several alias addresses corresponding to different people or groups of people and create a custom “autoreply” message that will be sent when the user is unavailable. For example, when the user is out of the office on vacation, a first message such as “I am finally taking a break from work and will be back in two weeks” may be sent the user's friends and a second message such as “I will be out of the office for two weeks, please contact my secretary at 555-1234 if this an urgent matter” can be sent to business associates. The user can also have messages addressed to certain e-mail addresses forwarded to a mobile device, such as a mobile telephone or personal digital assistant (PDA).

While the present invention has been described in connection with the illustrated embodiments, it will be appreciated and understood that modifications can be made without departing from the true spirit and scope of the invention. Furthermore, the present invention may be implemented with a computer readable medium have computer-executable instructions for performing the disclosed methods.

I claim:

1. A method of routing electronic mail messages to a user with a server, the method comprising the steps of:
(1) receiving at a mail server an electronic mail message having a destination address;
(2) receiving from a user at the mail server an identification of a main electronic mail address and at least one alias electronic mail address;
(3) comparing the destination address to the main and at least one alias electronic mail addresses; and
(4) transmitting the electronic mail message to an address determined as a result of the comparing step.

2. The method of claim 1, wherein step (4) comprises:
transmitting the electronic mail message to the destination address when the destination address is indicated as a main address; and
transmitting the electronic mail message to a main address when the destination address is indicated as an alias address corresponding to the main address.

3. A method of providing an electronic mail service to users, the method comprising the steps of:
(1) registering a main electronic mail address for a user;
(2) providing at least one alias electronic mail address to the user; and
(3) delivering electronic messages addressed to the main address and electronic mail messages addressed to the at least one alias address to a single electronic mail inbox.

4. The method of claim 3, further including the step of:
(4) allowing the user to manage the at least one alias electronic mail address.

5. The method of claim 4, wherein the allowing steps comprises allowing the user to delete alias electronic mail addresses.

6. The method of claim 4, wherein the allowing steps comprises allowing the user to add alias electronic mail addresses.

7. The method of claim 3, further including the step of providing a record of electronic messages sent by and received by the at least one alias electronic mail address.

8. The method of claim 7, further including the step of displaying electronic messages received by the at least one alias electronic mail address.

9. The method of claim 3, further including the step of providing the main electronic mail address to the user.

10. An electronic mail server configured to perform the steps of:
(1) receiving an electronic mail message having a destination address;
(2) comparing the destination address to addresses included in a database of main and alias electronic mail addresses; and
(3) transmitting the electronic mail message to an address determined as a result of the comparing step.

11. The mail server of claim 10, wherein step (3) comprises:
transmitting the electronic mail message to the destination address when the destination address is indicated as a main address in the database; and
transmitting the electronic mail message to a main address when the destination address is indicated as an alias address corresponding to the main address in the database.

12. A computer-readable medium having computer-executable instructions for performing the steps of:
comparing a destination address of an electronic mail message to addresses included in a database of main and alias electronic mail addresses; and
readdressing the electronic mail message to a main address when the destination address is indicated as an alias address corresponding to the main address.

13. An electronic mail system comprising:
an electronic mail server configured to perform the steps of:
(1) receiving an electronic mail message having a destination address;
(2) comparing the destination address to addresses included in a database of main and alias electronic mail addresses; and
(3) transmitting the electronic mail message to an address determined as a result of the comparing step; and
a computer coupled to the electronic mail server and including computer executable instructions that allow a user to send electronic mail messages from more than one electronic mail address with a single user interface.
